(19) United States
(12) Patent Application Publication
(10) Pub. No.: US 2017/0306883 A1
(43) Pub. Date: Oct. 26, 2017

(54) ENGINE BED PLATE

(71) Applicant: Hyundai Motor Company, Seoul (KR)

(72) Inventor: Byung Hyun LEE, Bucheon-si (KR)

(21) Appl. No.: 15/263,787

(22) Filed: Sep. 13, 2016

(30) Foreign Application Priority Data
Apr. 26, 2016 (KR) 10-2016-0051160

(51) Int. Cl. F02F 7/00; F01M 11/04; F01M 13/00

(52) U.S. Cl. CPC F02F 7/0065; F01M 13/00; F01M 11/0458; F01M 2013/0038

(57) ABSTRACT

An engine bed plate includes a plurality of partition walls provided in a casing and dividing an interior of the casing to define a plurality of crank chambers. A first ventilation hole is provided in a front wall and each of the plurality of partition walls. The first ventilation hole is formed in a horizontal direction to ventilate the plurality of crank chambers.

### CROSS REFERENCE TO RELATED APPLICATION

The present application claims the benefit of priority to Korean Patent Application No. 10-2016-0051160, filed Apr. 26, 2016 with the Korean Intellectual Property Office, the entirety of which is incorporated herein for all purposes by this reference.

### TECHNICAL FIELD

The present disclosure relates generally to an engine bed plate and, more particularly, to an engine bed plate configured to ventilate crank chambers of cylinders without causing degradation of the durability thereof.

### BACKGROUND

A vehicle engine serves to allow a piston to reciprocate by using thermal energy generated in a combustion process of burning fuel and provide running power by converting a linear reciprocating motion of a piston in a cylinder into a rotary motion via a connecting rod and a crankshaft.

Generally, an engine is provided with: a cylinder block having a cylinder in which a piston reciprocates; a cylinder head mounted on an upper portion of the cylinder block, the cylinder head having an intake valve and an exhaust valve provided therein to respectively introduce a fuel-air mixture into the cylinder and discharge combustion gas from the cylinder, and a camshaft that actuates the intake and exhaust valves; and an oil pan that is mounted below the cylinder block to collect used engine oil drained from working parts of the engine.

In the case of an engine having a short stroke cylinder block with a short skirt, the engine is configured to define crank chambers by mounting a ladder frame or an engine bed plate integrated with a main bearing cap at a location below the cylinder block with an oil pan mounted below the ladder frame.

Thus, the ladder frame or the engine bed plate plays an important role in the engine to secure a desired strength of a powertrain of a vehicle along with a cylinder block.

However, in the engine bed plate according to the related art, crank chambers do not communicate with each other and are not ventilated, and therefore when a piston moves downwards in a cylinder, the piston may fail to move smoothly downwards because of internal pressure in the crank chambers.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to provide an engine bed plate that maintains a desired strength thereof and ventilates crank chambers, thereby preventing pumping loss that may occur when a piston reciprocates in a cylinder.

In order to achieve the above object, according to one aspect, the present disclosure provides an engine bed plate including a plurality of partition walls provided in a casing and dividing an interior of the casing to define a plurality of crank chambers. A first ventilation hole is provided in a front wall and each of the plurality of partition walls. The first ventilation hole is formed in a horizontal direction to ventilate the plurality of crank chambers.

The first ventilation hole may be provided in a lower portion of the front wall and each of the plurality of partition walls.

The engine bed plate may further include an oil drain passage provided in a first side of each of the plurality of partition walls. The oil drain passage is formed through the partition wall in a vertical direction, and the first ventilation hole may be in communication with the oil drain passage.

The engine bed plate may further include a second ventilation hole provided on an upper end of a second side of at least one of the plurality of partition walls. The second ventilation hole is formed in a horizontal direction.

The engine bed plate may further include a bearing groove provided on an upper end of the front wall and each of the plurality of partition walls for supporting a crankshaft, and a third ventilation hole provided in the front wall and each of the plurality of partition walls at a location below the bearing groove. The third ventilation hole is formed in a horizontal direction.

The engine bed plate having the above-mentioned configuration can maintain a desired strength and can efficiently ventilate crank chambers. Thus, the engine bed plate is capable of minimizing pumping loss that may occur when a piston reciprocates in a cylinder and preventing degradation of durability of the engine bed plate.

### BRIEF DESCRIPTION OF THE DRAWINGS

The above and other objects, features and other advantages of the present disclosure will be more clearly understood from the following detailed description when taken in conjunction with the accompanying drawing, in which:

FIG. 1 is a perspective view illustrating an engine bed plate according to an exemplary embodiment in the present disclosure.

### DETAILED DESCRIPTION OF THE EMBODIMENTS

Hereinbelow, an exemplary embodiment of an engine bed plate in the present disclosure will be described with reference to the accompanying drawing.

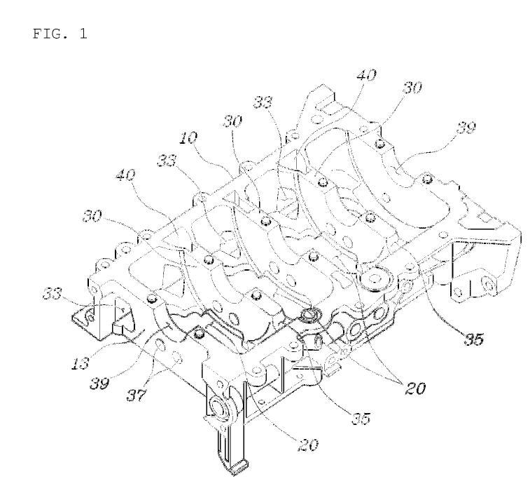

FIG. 1 is a perspective view illustrating an engine bed plate according to an exemplary embodiment. Referring to FIG. 1, the engine bed plate is provided with a plurality of partition walls 30 in a casing 10 to define a plurality of crank chambers 20 by dividing the interior of the casing 10, with a first ventilation hole 33 provided in each of the front wall 13 and the partition walls 30 of the casing 10 by being formed therethrough in a horizontal direction to ventilate the plurality of crank chambers 20.

The engine bed plate is configured to define hermetic crank chambers by a cylinder head mounted on the cylinder block and an oil pan mounted below the cylinder block. The crank chambers 20 are provided individually in a plurality of cylinders in the interior of the cylinder head to communicate with each other, and the plurality of partition walls 30 are provided in the interior of the casing 10 to define the plurality of crank chambers 20.

In an embodiment illustrated in FIG. 1, three partition walls 30 are provided in the interior of the casing 10 to define four crank chambers 20.

However, this is only an exemplary embodiment in the present disclosure and the number of the partition walls 30 may vary depending on the number of cylinders in the interior of the cylinder head. Thus, the number of the partition walls 30 is not limited to the specific number.

Particularly, according to the exemplary embodiment, the first ventilation hole 33 is provided in a lower portion of a first side of each of the front wall 13 and the partition walls 30.

One of the main functions of the engine bed plate is to support the cylinder head upwards by the casing 10 and the partition walls 30. Here, the first ventilation hole 33 may be provided in the front wall 13 and each of the partition walls of the casing 10 at a location in which the first ventilation hole 33 does not affect the supporting strength of the front wall 13 and the partition walls 30.

Therefore, according to the exemplary embodiment, the first ventilation hole 33 is provided in a lower portion of a first side of the front wall 13 and each of the partition walls 30. Thus, the engine bed plate is capable of preventing degradation of supporting strength and durability of the front wall 13 and the partition walls 30.

Specifically, an oil drain passage 40 may be provided in a first side of each of the partition walls 30 by being formed through the partition wall in a vertical direction, and the first ventilation hole 33 may be in communication with the oil drain passage 40.

The oil drain passage 40 serves to guide used engine oil drained from a cylinder block at a location on a first side of the partition walls 30 into an oil pan mounted below the cylinder block, and the first ventilation hole 33 may be formed towards the oil drain passage 40. Thus, the engine bed plate reduces inconvenience in a manufacturing process.

In addition, in the case of forming the first ventilation hole 33 to communicate with the oil drain passage 40, the first ventilation hole 33 may be formed by using upper and lower parts of using a high-pressure die casting mold. Thus, the first ventilation hole 33 may be formed in the partition walls via a single casting process without undergoing an additional process.

Furthermore, a second ventilation hole 35 may be provided on the upper end of a second side of at least one of the plurality of partition walls 30 by being formed through in a horizontal direction.

Moreover, a bearing groove 39 may be provided on the upper end of each of the front wall 13 and the partition walls 30 for supporting a crankshaft, and a third ventilation hole 37 may be provided in the front wall and each of the partition walls at a location below the bearing groove 39 by being formed through in a horizontal direction.

As a result, the second ventilation hole 35 and the third ventilation hole 37 serve to maximize ventilation performance in the plurality of crank chambers 20 of the cylinder. Thus, the engine bed plate can reduce pumping loss that may occur when a piston reciprocates in the cylinder.

The engine bed plate having the above-mentioned configuration can efficiently ventilate the crank chambers while maintaining a desired strength. Thus, the engine bed plate of the present invention can minimize pumping loss that may occur when a piston reciprocates in a cylinder and can prevent degradation of durability of the engine bed plate.

Although an exemplary embodiment in the present disclosure has been described for illustrative purposes, those skilled in the art will appreciate that various modifications, additions and substitutions are possible, without departing from the scope and spirit of the invention as disclosed in the accompanying claims.

What is claimed is:

1. An engine bed plate, comprising:
a plurality of partition walls provided in a casing and dividing an interior of the casing to define a plurality of crank chambers; and
a first ventilation hole provided in a front wall and each of the plurality of partition walls, the first ventilation hole being formed in a horizontal direction to ventilate the plurality of crank chambers.

2. The engine bed plate of claim 1, wherein the first ventilation hole is provided in a lower portion of the front wall and each of the plurality of partition walls.

3. The engine bed plate of claim 2, further comprising an oil drain passage provided in a first side of each of the plurality of partition walls, the oil drain passage being formed through the partition wall in a vertical direction, wherein the first ventilation hole is in communication with the oil drain passage.

4. The engine bed plate of claim 1, further comprising a second ventilation hole provided on an upper end of a second side of at least one of the plurality of partition walls, the second ventilation hole being formed in a horizontal direction.

5. The engine bed plate of claim 1, further comprising a bearing groove provided on an upper end of the front wall and each of the plurality of partition walls for supporting a crankshaft, and a third ventilation hole provided in the front wall and each of the plurality of partition walls at a location below the bearing groove, the third ventilation hole being formed in a horizontal direction.
